(19) United States
(12) Patent Application Publication
(10) Pub. No.: US 2016/0314870 A1
(43) Pub. Date: Oct. 27, 2016

(54) INSULATED WIRE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Tsuyoshi NONAKA, Yokkaichi, Mie (JP)

(21) Appl. No.: 15/104,841

(22) PCT Filed: Nov. 28, 2014
(86) PCT No.: PCT/JP2014/081501

§ 371 Date: Jun. 15, 2016

(30) Foreign Application Priority Data
Dec. 19, 2013 (JP) 2013-262258

(51) Int. Cl. H01B 3/46; H01B 7/29

(52) U.S. Cl. CPC H01B 3/46; H01B 7/292

(57) ABSTRACT

An insulated wire that includes an insulating layer containing crosslinked silicone rubber and that has good wear resistance and good gasoline resistance is provided. An insulated wire is obtained by covering a conductor with an insulating layer containing crosslinked silicone rubber. The insulated wire is configured such that a change in elastic modulus in a radial direction is not more than 20%, the change in elastic modulus being determined using elastic moduli at multiple different positions in a radial direction of the insulating layer based on Equation (1):

Change in elastic modulus (%)=[(maximum value of elastic modulus−minimum value of elastic modulus)/maximum value of elastic modulus]×100.

### TECHNICAL FIELD

The present invention relates to an insulated wire, and particularly to an insulated wire to be preferably used in an automobile, an electric/electronic apparatus, and the like.

### BACKGROUND ART

Insulating materials for insulated wires to be used in vehicles such as automobiles are required to have various characteristics such as certain mechanical characteristics, flame retardancy, heat resistance, and cold resistance. Conventionally, as these types of insulating materials, materials containing halogen, such as polyvinyl chloride resins and compounds into which a halogen flame retardant is blended, are often used.

Since these types of insulating materials contain halogen, when they are disposed of by being incinerated, corrosive gas is generated in some cases. Therefore, from the viewpoint of environmental protection and the like, attempts have been made to use insulating materials containing no halogen.

Patent Document 1 states that a non-halogen insulating material obtained by blending aluminum hydroxide with uncrosslinked silicone rubber is used as the insulating material for an insulated wire, for example. The silicone rubber subjected to heating is used as crosslinked silicone rubber.

### CITATION LIST

### Patent Document

Patent Document 1: Japanese Patent No. 3555101

### SUMMARY OF INVENTION

### Technical Problem

When insulated wires in which crosslinked silicone rubber is used in an insulating layer is used in automobiles and the like, an improvement in wear resistance and gasoline resistance is desired. In particular, when no filler is added to the insulating layer including crosslinked silicone rubber, the wear resistance and the gasoline resistance have a strong tendency to decrease.

The problem to be solved by the present invention is to provide an insulated wire that includes an insulating layer containing crosslinked silicone rubber and that has good wear resistance and good gasoline resistance.

### Solution to Problem

In order to solve the foregoing problems, an insulated wire according to the present invention is an insulated wire, wherein a conductor is covered with an insulating layer containing crosslinked silicone rubber, a change in elastic modulus in a radial direction being not more than 20%, the change in elastic modulus being determined using elastic moduli at multiple different positions in a radial direction of the insulating layer based on Equation (1):

Change in elastic modulus (%)=[(maximum value of elastic modulus−minimum value of elastic modulus)/maximum value of elastic modulus]×100 (1).

In the insulated wire according to the present invention, it is preferable that the multiple different positions in the radial direction of the insulating layer are three points that are a point located at substantially a center in the radial direction, a point located on an outer side with respect to the central point, and a point located on an inner side with respect to the central point.

In the insulated wire according to the present invention, it is preferable that the crosslinked silicone rubber has a Shore A hardness of at least 50.

The insulated wire according to the present invention can be configured such that the insulating layer contains no filler.

The insulated wire according to the present invention can be configured such that the insulating layer contains a filler.

In the insulated wire according to the present invention, it is preferable that the filler is at least one selected from the group consisting of calcium carbonate, barium sulfate, clay, talc, magnesium hydroxide, and magnesium oxide.

### Advantageous Effects of the Invention

The insulated wire according to the present invention is an insulated wire in which a conductor is covered with an insulating layer containing crosslinked silicone rubber. In this insulated wire, a change in elastic modulus in a radial direction of the insulating layer is not more than 20%, and therefore, the degrees of crosslinking on the surface side and the inner side in the thickness direction of the insulating layer are uniform, thus making it possible to improve the wear resistance and the gasoline resistance.

### BRIEF DESCRIPTION OF DRAWINGS

FIG. 1(a) is a partially cutaway perspective view illustrating an example of an insulated wire according to the present invention, and FIG. 1(b) is a cross-sectional view taken along line B-B in FIG. 1(a).

FIG. 2 is an explanatory diagram illustrating a method for measuring a change in elastic modulus of examples.

### DESCRIPTION OF EMBODIMENTS

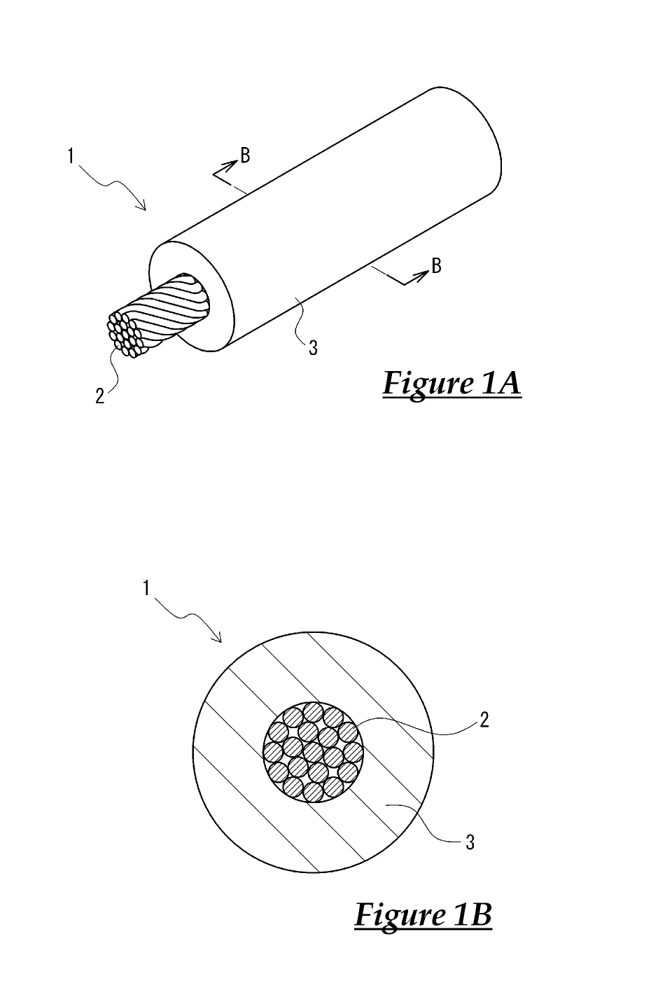

An embodiment of the present invention will be described in detail. FIG. 1(a) is a partially cutaway perspective view illustrating an example of an insulated wire according to the present invention, and FIG. 1(b) is a cross-sectional view taken along line B-B in FIG. 1(a). As shown in FIGS. 1(a) and 1(b), an insulated wire 1 according to the present invention includes at least a conductor 2 and an insulating layer 3 that covers the conductor. The insulating layer 3 contains at least crosslinked silicone rubber.

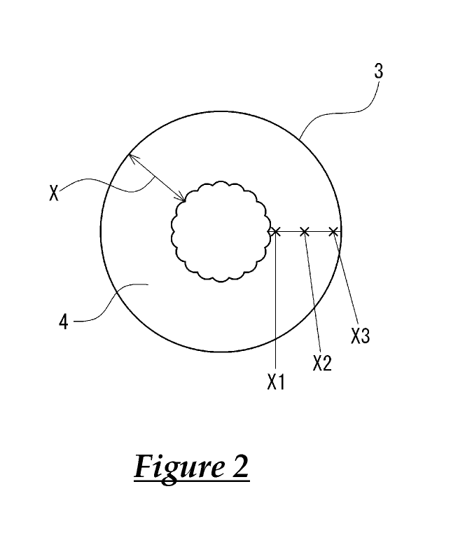

In the insulated wire 1 according to the present invention, a change in elastic modulus in a radial direction of the insulating layer 3 is not more than 20%. FIG. 2 is an explanatory diagram illustrating a method for measuring a change in elastic modulus of the insulating layer of the present invention. The change in elastic modulus can be determined based on Equation (1) below by measuring the elastic moduli of at least three positions that are located at different depths in the radial direction, namely the thickness direction, of the insulating layer 3 and determining the maximum value and the minimum value.

Change in elastic modulus (%)=[(maximum value of elastic modulus−minimum value of elastic modulus)/maximum value of elastic modulus]×100 (1).

The elastic modulus can be measured in accordance with the following procedure. Only the insulating layer 3 is obtained by pulling out the conductor 2 from the insulated wire 1. Next, the insulating layer 3 is cut at a predetermined position in the radial direction using a microtome or the like, and the section is polished. Three suitable points on the section are selected, and the elastic moduli are measured using a nanoindenter. FIG. 2 shows the section of the insulating layer. As shown in FIG. 2, the elastic moduli are measured at three points, namely a point X1 on the inner side (conductor side), a point X2 near the center, and a point X3 on the surface side, in a radial direction X of a section 4 of the insulating layer 3. The change in elastic modulus is determined using the maximum value and the minimum value of the measurement values of the elastic moduli based on Equation (1).

The elastic modulus of the insulating layer can be measured using a nanoindenter (microindentation hardness testing apparatus). The elastic modulus is an indentation elastic modulus. A nanoindenter is an apparatus that can control indentation load in the μN order and track the depth of an indenter during indentation in the nm order. Various commercially available apparatus can be used.

The insulating layer 3 is crosslinked. Silicone resin in the insulating layer 3 is generally crosslinked with peroxide vulcanization in which a peroxide is used as a crosslinking agent. The crosslinking density of the insulating layer 3 changes depending on the degree of heating. A portion to which a larger amount of heat is applied is more likely to be crosslinked. In general, a smaller amount of heat is applied to the conductor side (inner side) of the insulating layer 3 in the radial direction during crosslinking compared with the outer side thereof. Therefore, as the inner side and the outer side in the radial direction, the crosslinking density may vary depending on the depth from the surface of the insulating layer 3 in the thickness direction. When the crosslinking density changes and decreases in this manner, chemicals such as gasoline easily infiltrate, and thus the gasoline resistance deteriorates. In addition, the wear resistance and the like also deteriorate. Therefore, it is important to make the crosslinking densities in the radial direction of the insulating layer 3 uniform from the viewpoint of the gasoline resistance, the wear resistance, and the like.

In the present invention, the variation in crosslinking density in the radial direction could be reduced by setting the changes of elastic moduli that were measured at multiple suitable positions located at different depths in the radial direction (change in elastic modulus) to not more than 20%, in order to reduce the difference in crosslinking density in the radial direction of the insulating layer 3. The magnitude of the elastic modulus correlates with the magnitude of the crosslinking density. The larger the crosslinking density, the larger the elastic modulus. If the change in elastic modulus exceeds 20%, the difference in crosslinking density increases, and thus the gasoline resistance, the wear resistance, and the like deteriorate.

When the elastic moduli of the multiple positions located at different depths in the radial direction are measured, it is sufficient if the elastic moduli of at least two points are measured. It is preferable that as shown in FIG. 2, the elastic moduli are measured at three points at suitable positions in the radial direction X, namely the point (center) X2 located at substantially the center, the point X3 located on the outer side with respect to the center X2, and the point X1 located on the inner side with respect to the center X2. The elastic moduli may also be measured at four or more positions located at different depths in the radial direction.

In order to set the change in elastic modulus of the insulating layer 3 to not more than 20%, it is sufficient if a means with which a crosslinking reaction uniformly proceeds in the insulating layer 3 is selected such that the difference in crosslinking density between the outer side and the inner side is reduced during the crosslinking of the insulating layer 3. Specific examples of a method for making the crosslinking density of the insulating layer 3 uniform include methods in response to the composition of the insulating layer, the manufacturing conditions under which the insulating layer is formed by extrusion, a heating method with which the insulating layer is crosslinked, and the like. Specifically, the following method can be used.

With regard to the composition of the insulating layer 3, the hardness of crosslinked silicone resin is selected. In general, the higher the hardness, the smaller the change in elastic modulus. The change in elastic modulus is also reduced by adding a filler to the composition. The change in elastic modulus is also reduced by increasing the addition amount of the crosslinking agent in the composition.

With regard to the conditions under which the insulating layer 3 is formed by extrusion, a linear speed, a temperature, and the like are selected. When the heating temperature is increased, the change in elastic modulus is likely to be reduced, but there is a risk that the insulating layer burns due to a excessively high temperature. When the extruding speed (linear speed) is increased, the change in elastic modulus is reduced, but there is a risk of the formation of bubbles.

With regard to the heating conditions of crosslinking and the like, any appropriate means can be used depending on the heating method. During the crosslinking, hot-air heating (hot-air vulcanization) or steam heating (steam vulcanization) is performed, for example. When the hot-air vulcanization is performed, heat is transmitted from the outer side to the inner side by thermal conduction of the insulating layer 3. The crosslinking reaction depends on the thermal conductivity of the insulating layer 3. When the hot-air vulcanization is performed, an increase in thermal conductivity of the composition is effective in reducing changes in elastic modulus.

When the steam vulcanization is performed, heat is transmitted from the outer side to the inner side by steam infiltrating the insulating layer 3 from the outer side to the inner side. In this case, the crosslinking reaction depends on the steam permeability of the insulating layer 3. Therefore, the hydrophilicity, the air permeability, and the like of the composition are adjusted to improve the steam permeability, thus making it possible to reduce changes in elastic modulus.

The insulating layer 3 may contain no filler and be constituted by only crosslinked silicone rubber or it may contain a filler. When the insulating layer contains no filler, it is preferable that the crosslinked silicone rubber has a Shore A hardness of at least 50. If the insulating layer contains no filler, there is a risk that the wear resistance of the insulating layer including only the crosslinked silicone rubber is insufficient, but when the crosslinked silicone rubber has a Shore A hardness of at least 50, sufficient wear resistance can be obtained.

The above-mentioned Shore A hardness refers to a hardness measured in a spring type hardness test using a type-A durometer in accordance with JIS K 6253.

There is no particular limitation to the filler added to the above-mentioned insulating layer, and examples thereof include calcium carbonate, barium sulfate, clay, talc, magnesium hydroxide, and magnesium oxide. The above-mentioned filler may be a filler subjected to a surface treatment or an untreated filler that is not subjected to a surface treatment.

It is preferable that the above-mentioned filler has an average particle diameter of not more than 1 μm from the viewpoint of dispersibility and the like.

Examples of the above-mentioned calcium carbonate include materials such as Hakuenka CC (0.05 μm) (BET=27), Hakuenka CCR (0.08 μm) (BET=18), Hakuenka DD (0.05 μm) (BET=23), Vigot 10 (0.1 μm) (BET=12), Vigot 15 (0.15 μm) (BET=9.3), and Hakuenka U (0.04 μm) (BET=26), which are manufactured by Shiraishi Calcium Kaisha, Ltd. The values in parentheses are the average particle diameter and the BET specific surface area (m²/g) (the same applies hereinafter).

Examples of the above-mentioned magnesium oxide include materials such as UC95S (3.1 μm) (BET=21), UC95M (3.0 μm) (BET=8.5), and UC95H (3.3 μm) (BET=6.0), which are manufactured by Ube Material Industries, Ltd.

Examples of the above-mentioned magnesium hydroxide include materials such as UD-651-1 (3.5 μm) (BET=29) and UD-653 (3.5 μm) (BET=22), which are manufactured by Ube Material Industries, Ltd.

A surface treatment may be performed on the above-mentioned filler. As a surface treating agent, a homopolymer of a-olefin such as 1-heptene, 1-octene, 1-nonene, or 1-decene, a mutual copolymer thereof, or a mixture thereof can be used.

The above-mentioned surface treating agent may be modified. As a modifying agent, unsaturated carboxylic acid and a derivative thereof can be used. Specific examples of the unsaturated carboxylic acid include maleic acid and fumaric acid. Examples of the derivative of unsaturated carboxylic acid include maleic anhydride (MAH), maleic monoester, and maleic diester. Of these, maleic acid and maleic anhydride are preferable. It should be noted that these may be used alone or in a combination of two or more.

Examples of a method for introducing acid into a surface treating agent include a grafting method and a direct method. The acid-modified amount is 0.1 to 20 mass % of the above-mentioned polymer, preferably 0.2 to 10 mass %, and more preferably 0.2 to 5 mass %.

Various silane coupling agents may be used as the above-mentioned surface treating agent for a filler.

The average particle diameter of the filler is 0.01 to 20 μm, preferably 0.02 to 10 μm, and more preferably 0.03 to 8 μm. If the average particle diameter of the filler is less than 0.01 μm, secondary aggregation is likely to occur and the mechanical characteristics deteriorate. If the average particle diameter of the filler is more than 20 μm, the shape of the electric wire tends to have a poor external appearance.

It is preferable that the content of the filler in the insulating layer is in a range of 0.1 to 100 parts by mass with respect to 100 parts by mass of the crosslinked silicone rubber. If the content of the filler is less than 0.1 parts by mass, there is a risk that the wear resistance is insufficient. If the content of the filler exceeds 100 parts by mass, there is a risk that the electric wire has a poor external appearance.

The crosslinked silicone rubber in the insulating layer is obtained by crosslinking uncrosslinked silicone rubber.

As the above-mentioned uncrosslinked silicone rubber, a millable type (heat-crosslinking type), which forms an elastic body by being heated and crosslinked after being kneaded with a crosslinking agent, or a liquid rubber type, which is in a liquid form before being crosslinked, may be used. There are two types of the liquid rubber type silicone rubber: one is a room temperature crosslinking type (RTV), which can be crosslinked at near room temperature; and the other is a low temperature crosslinking type (LTV), which is crosslinked by being heated at near 100° C. after mixing.

A millable type silicone rubber that is commercially available as a rubber compound obtained by blending linear organopolysiloxane serving as a principal material (raw rubber) with a dispersion accelerator, other additives, and the like may be used.

In the rubber composition for an insulating layer, the uncrosslinked silicone rubber can be crosslinked by heating or the like, but a crosslinking agent (vulcanizing agent) may be added to the composition to crosslink the uncrosslinked silicone rubber.

The crosslinking agent can be selected as appropriate depending on the type of the uncrosslinked rubber, crosslinking condition, and the like. Examples of the crosslinking agent include radical generators such as organic peroxides, and compounds such as metal soap, amine, thiol, thiocarbamate, and organic carboxylic acid. From the viewpoint of improving the crosslinking speed, organic peroxides are preferable as the crosslinking agent.

Examples of the organic peroxides include Perhexyl D, Percumyl D, Perhexa V, Perbutyl D, and Perhexa 25B, which are manufactured by NOF Corporation.

The blend amount of the crosslinking agent can be determined as appropriate. It is preferable that the blend amount of the crosslinking agent is in a range of 0.01 to 10 mass % with respect to the total amount of the uncrosslinked silicone rubber and the crosslinking agent, for example.

The composition of the insulating layer 3 may contain various additives other than the crosslinked silicone rubber, the filler, the crosslinking agent, and the like as long as the characteristics of the insulating layer are not deteriorated. Examples of such additives include common additives to be used in an insulating layer of an insulated wire. Specific examples thereof include a flame retardant, an antioxidant, an age resistor, and a pigment.

The insulated wire 1 according to the present invention can be manufactured as described below, for example. First, a rubber composition for an insulating layer to be used to form the insulating layer 3 is prepared. Next, a coating layer containing uncrosslinked rubber is molded around the conductor 2 by extruding the prepared rubber composition around the conductor 2. Then, the uncrosslinked rubber in the coating layer is crosslinked using a crosslinking means such as heating. Accordingly, the insulated wire 1 is obtained in which the conductor 2 is covered with the insulating layer 3 containing crosslinked rubber.

The insulating layer 3 may also be crosslinked by coating a conductor with a rubber composition for an insulating layer to form a coating layer and by crosslinking uncrosslinked rubber in the coating layer using a crosslinking means such as heating.

The rubber composition used to form the insulating layer 3 can be prepared by kneading the uncrosslinked silicone rubber with various additives such as a crosslinking agent, which are optionally blended. When the components of the rubber composition are kneaded, an ordinary kneading machine such as a Banbury mixer, a pressurizing kneader, a kneading extruder, a twin-screw kneading extruder, or a roll can be used to uniformly disperse the components.

A wire extrusion molding machine or the like used to manufacture regular insulated wires can be used to subject the rubber composition to the extrusion molding.

As the conductor 2 of the insulated wire 1, a conductor used in regular insulated wires can be used. Examples of the conductor include a single wire conductor and a twisted wire conductor that are made of a copper-based material or an aluminum-based material. The diameter of the conductor and the thickness of the insulating layer are not particularly limited and can be determined as appropriate depending on the application of the insulated wire and the like.

Although the embodiment of the present invention has been described in detail, the present invention is not limited to the above-mentioned embodiment, and various modifications can be made without departing from the gist of the present invention. For example, although the insulated wire of the above-mentioned embodiment includes an insulating layer constituted by a single layer, the insulating layer may also include not less than two layers.

The insulated wire according to the present invention can be used as an insulated wire to be used in automobiles and electric/electronic apparatuses. In particular, the insulated wire according to the present invention is preferable as an insulated wire to be used for the purposes that require high heat resistance and high gasoline resistance.

### EXAMPLES

Hereinafter, examples and comparative examples of the present invention will be described.

### Examples 1 to 7

A rubber composition for an insulating layer containing uncrosslinked silicone rubber, a filler, and a crosslinking agent in accordance with the blend composition shown in Table 1 was mixed using a Banbury mixer at room temperature. Then, the rubber composition for an insulating layer was extruded using an extrusion molding machine to cover the outer circumference of a conductor (with a cross-sectional area of 0.5 mm²) constituted by an annealed copper twisted wire obtained by twisting seven annealed copper wires with a thickness of 0.2 mm, and an insulating layer containing uncrosslinked rubber was formed. Next, heat treatment was performed on the insulating layer by heating the insulated wire using hot air at 200° C. for 4 hours to crosslink the uncrosslinked rubber, and thus the insulated wires of Examples 1 to 7 were obtained.

### Comparative Examples 1 to 7

The insulated wires of Comparative Examples 1 to 7 were obtained in the same manner as in the examples, except that a rubber composition containing uncrosslinked silicone rubber and a crosslinking agent in accordance with a blend composition shown in Table 2 was used.

The insulated wires of Examples 1 to 7 and Comparative Examples 1 to 7 were subjected to measurement of a change in elastic modulus in the radial direction, a cold resistance test, a wear resistance test, and a gasoline resistance test, and evaluated. The results are collectively shown in Table 1 and Table 2. It should be noted that the details of the components, the test methods, and the evaluation criteria shown in Table 1 and Table 2 are as mentioned below.

### Silicone Rubber (Heat Curable Silicone Elastomer)

Silicone rubber 1: “R401-50” (Shore A hardness 50) manufactured by Wacker Asahikasei Silicone Co., Ltd.

Silicone rubber 2: “R401-60” (Shore A hardness 60) manufactured by Wacker Asahikasei Silicone Co., Ltd.

Silicone rubber 3: “R401-70” (Shore A hardness 70) manufactured by Wacker Asahikasei Silicone Co., Ltd.

Silicone rubber 4: “R401-80” (Shore A hardness 80) manufactured by Wacker Asahikasei Silicone Co., Ltd.

Silicone rubber 5: “R401-40” (Shore A hardness 40) manufactured by Wacker Asahikasei Silicone Co., Ltd.

Silicone rubber 6: “R401-30” (Shore A hardness 30) manufactured by Wacker Asahikasei Silicone Co., Ltd.

Silicone rubber 7: “R401-20” (Shore A hardness 20) manufactured by Wacker Asahikasei Silicone Co., Ltd.

Silicone rubber 8: “SH0030U” (Shore A hardness 30) manufactured by KCC Corporation

### Filler

Filler 1: calcium carbonate, “Vigot 10” manufactured by Shiraishi Calcium Kaisha, Ltd.

Filler 2: magnesium hydroxide, “UD-653” manufactured by Ube Material Industries, Ltd.

### Crosslinking Agent

Crosslinking agent: di-t-hexyl peroxide, “Perhexyl D” manufactured by NOF Corporation

### Method for Measuring Change in Elastic Modulus in Radial Direction

Only the insulating layer was obtained by pulling out the conductor from the insulated wire, which was cut to a predetermined length. Next, the insulating layer was cut at any position in the radial direction using a microtome, and the surface of the section was polished. As shown in FIG. 2, the indentation elastic moduli of this section were measured at three points located at different depths in the radial direction, namely the point X1 on the inner side, the point X2 at the center, and the point X3 on the outer side, using a nanoindenter apparatus (“Triboindenter” manufactured by Hysitron, Inc.). The maximum value and the minimum value of the measurement values of the elastic moduli at the above-mentioned three points were selected, and the change in elastic modulus (%) in the radial direction was determined based on Equation (1) above. The depth of the measurement points X1, X2, and X3 from the surface of the insulating layer in the thickness direction were 150 μm, 200 μm, and 50 μm, respectively.

### Cold Resistance Test Method

The cold resistance test was performed in accordance with JIS C3055. Specifically, the produced insulated wire was cut to a length of 38 mm and used as a test piece. This test piece was attached to a cold resistance test machine, cooled to a predetermined temperature, and hit with a hitting tool. After that, the state of the test piece after hitting was observed. Five test pieces were used, and a temperature at which all of the five test pieces were broken was determined as a cold resistant temperature.

### Wear Resistance Test Method

The wear resistance test was performed using a blade reciprocating method in accordance with the standard JASO D618 of Society of Automotive Engineers of Japan. Specifically, the insulated wires of the examples and comparative examples were cut to a length of 750 mm and used as a test piece. A blade was reciprocated on the coating material (insulating layer) of the test piece in a length of at least 10 mm at a speed of 50 times per minute in the axial direction at room temperature of 23±5° C., and the number of reciprocations was counted until the blade reached the conductor. In this case, the load applied to the blade was set to 7 N. If the number of reciprocations was at least 200, the evaluation was “Good”. If the number of reciprocations was at least 300, the evaluation was “Excellent”. If the number of reciprocations was less than 200, the evaluation was “Poor”.

### Gasoline Resistance Test Method

The gasoline resistance test was performed in accordance with Method 2 of ISO 6722 (2011). Specifically, the outer diameter of an electric wire that had been immersed in liquid C according to ISO 1817 at 23° C. for 20 hours was measured, and the rate of change in the outer diameter of the electric wire was calculated. If the maximum rate of change was not more than 15%, the evaluation was “Good”. If the maximum rate of change was not more than 10%, the evaluation was “Excellent”. If the maximum rate of change was more than 15%, the evaluation was “Poor”.

TABLE 1

| | Examples | | | | | | |
|---|---|---|---|---|---|---|---|
| | 1 | 2 | 3 | 4 | 5 | 6 | 7 |
| Blend composition of insulated layer (parts by mass) | | | | | | | |
| Silicone rubber 1 | 100 | 100 | — | — | — | — | — |
| (Asahikasei: R401-50) (Hardness 50) | | | | | | | |
| Silicone rubber 2 | — | — | 100 | — | — | — | 100 |
| (Asahikasei: R401-60) (Hardness 60) | | | | | | | |
| Silicone rubber 3 | — | — | — | 100 | — | 100 | — |
| (Asahikasei: R401-70) (Hardness 70) | | | | | | | |
| Silicone rubber 4 | — | — | — | — | 100 | — | — |
| (Asahikasei: R401-80) (Hardness 80) | | | | | | | |
| Filler 1 (Vigot 10) | — | — | — | — | — | 5 | — |
| Filler 2 (UD653) | 5 | — | — | — | — | — | 10 |
| Crosslinking agent (Perhexyl D) | 3 | 2 | 3 | 3 | 5 | 3 | 1 |
| Change in elastic modulus in radial direction (%) | 10 | 18 | 8 | 6 | 5 | 7 | 15 |
| Test results | | | | | | | |
| Cold resistance (° C.) | −30 | −35 | −35 | −35 | −30 | −30 | −30 |
| Wear resistance | Excellent | Good | Good | Good | Good | Excellent | Excellent |
| Gasoline resistance | Excellent | Good | Good | Good | Excellent | Excellent | Excellent |

TABLE 2

| | Comparative Examples | | | | | | |
|---|---|---|---|---|---|---|---|
| | 1 | 2 | 3 | 4 | 5 | 6 | 7 |
| Blend composition of insulated layer (parts by mass) | | | | | | | |
| Silicone rubber 5 | 100 | — | — | — | — | 100 | — |
| (Asahikasei: R401-40) (Hardness 40) | | | | | | | |
| Silicone rubber 6 | — | 100 | — | — | — | — | 100 |
| (Asahikasei: R401-30) (Hardness 30) | | | | | | | |
| Silicone rubber 7 | — | — | 100 | — | 100 | — | — |
| (Asahikasei: R401-20) (Hardness 20) | | | | | | | |
| Silicone rubber 8 | — | — | — | 100 | — | — | — |
| (KCC: SH0030U) (Hardness 30) | | | | | | | |
| Crosslinking agent (Perhexyl D) | 0.5 | 1 | 0.5 | 0.5 | 1 | 1 | 0.5 |
| Change in elastic modulus in radial direction (%) | 23 | 24 | 30 | 28 | 27 | 21 | 26 |
| Test results | | | | | | | |
| Cold resistance (° C.) | −35 | −35 | −40 | −40 | −40 | −35 | −35 |
| Wear resistance | Poor | Poor | Poor | Poor | Poor | Poor | Poor |
| Gasoline resistance | Poor | Poor | Poor | Poor | Poor | Poor | Poor |

As shown in Table 2, with regard to the insulated wires of Comparative Examples 1 to 7, the change in elastic modulus in the radial direction was more than 20%, and the wear resistance and the gasoline resistance were poor. In contrast, as shown in Table 1, with regard to the insulated wires of Examples 1 to 7, the change in elastic modulus in the radial direction was not more than 20%, and thus the gasoline resistance was good. Examples 1 to 7 also had a good wear resistance.

Although the embodiment of the present invention has been described in detail, the present invention is not limited to the above-mentioned embodiment, and various modifications can be made without departing from the gist of the present invention.

1. An insulated wire, wherein a conductor is covered with an insulating layer containing crosslinked silicone rubber,
a change in elastic modulus in a radial direction being not more than 20%, the change in elastic modulus being determined using elastic moduli at multiple different positions in a radial direction of the insulating layer based on Equation (1):
Change in elastic modulus (%)=[(maximum value of elastic modulus−minimum value of elastic modulus)/maximum value of elastic modulus]×100

2. The insulated wire according to claim 1, wherein the multiple different positions in the radial direction of the insulating layer are three points that are a point located at substantially a center in the radial direction, a point located on an outer side with respect to the central point, and a point located on an inner side with respect to the central point.

3. The insulated wire according to claim 1, wherein the crosslinked silicone rubber has a Shore A hardness of at least 50.

4. The insulated wire according to claim 1, wherein the insulating layer contains no filler.

5. The insulated wire according to claim 1, wherein the insulating layer contains a filler.

6. The insulated wire according to claim 5, wherein the filler is at least one selected from the group consisting of calcium carbonate, barium sulfate, clay, talc, magnesium hydroxide, and magnesium oxide.

7. The insulated wire according to claim 2, wherein the crosslinked silicone rubber has a Shore A hardness of at least 50.

8. The insulated wire according to claim 2, wherein the insulating layer contains no filler.

9. The insulated wire according to claim 3, wherein the insulating layer contains no filler.

10. The insulated wire according to claim 2, wherein the insulating layer contains a filler.

11. The insulated wire according to claim 3, wherein the insulating layer contains a filler.
